(19) United States
(12) Patent Application Publication
(10) Pub. No.: US 2018/0176491 A1
(43) Pub. Date: Jun. 21, 2018

(54) IMAGE PICKUP DEVICE

(71) Applicant: Renesas Electronics Corporation, Tokyo (JP)

(72) Inventor: Fumihide MURAO, Tokyo (JP)

(73) Assignee: Renesas Electronics Corporation, Tokyo (JP)

(21) Appl. No.: 15/806,911

(22) Filed: Nov. 8, 2017

(30) Foreign Application Priority Data
Dec. 15, 2016 (JP) 2016-243520

(51) Int. Cl. H04N 5/361; H04N 5/374; H04N 5/378

(52) U.S. Cl. CPC H04N 5/361; H04N 5/378; H04N 5/374

(57) ABSTRACT

In a related image pickup device, there is a problem that an effect of noises that are superimposed on a signal on a signal reading path from a pixel circuit cannot be reduced. According to an embodiment, an image pickup device includes a first sampling-and-holding circuit 51 configured to sample a signal output from a pixel circuit, a buffer circuit 52 configured to amplify a signal held in the first sampling-and-holding circuit 51, and a second sampling-and-holding circuit 53 configured to sample a signal output from the buffer circuit 52, in which the image pickup device obtains a digital value corresponding to a signal output from the pixel circuit by passing the signal output from the pixel circuit through the first sampling-and-holding circuit 51, the buffer circuit 52, and the second sampling-and-holding circuit 53 in this order, and thereby transmitting the signal to an analog/digital conversion circuit 24.

### CROSS-REFERENCE TO RELATED APPLICATIONS

This application is based upon and claims the benefit of priority from Japanese patent application No. 2016-243520, filed on Dec. 15, 2016, the disclosure of which is incorporated herein in its entirety by reference.

### BACKGROUND

The present disclosure relates to an image pickup device. For example, the present disclosure relates to an image pickup device that reads a dark level signal, which is obtained when a floating diffusion is reset, and an image pickup signal, which is output according to an amount of light received by a light-receiving element, and outputs a digital value corresponding to a signal level of a signal that is obtained in a pixel based on a difference between the two read signals.

Japanese Unexamined Patent Application Publication No. 2009-253930 discloses an example of a circuit configuration for an image pickup device. In the circuit configuration disclosed in Japanese Unexamined Patent Application Publication No. 2009-253930, the image pickup device includes a photodiode, a signal holding circuit that holds each of a photocurrent detection signal corresponding an amount of a photocurrent of the photodiode and a dark-current detection signal corresponding to an amount of a dark-current of the photodiode, a buffer that buffers, amplifies, and successively outputs photocurrent detection signals and dark-current detection signals successively input from the signal holding circuit, a signal subtraction circuit that generates difference signals between the photocurrent detection signals and the dark-current detection signals successively input from the buffer, and a sampling-and-holding circuit 14 that holds and outputs the difference signals.

### SUMMARY

However, the present inventors have found the following problem. In the image pickup device disclosed in Japanese Unexamined Patent Application Publication No. 2009-253930, the photocurrent detection signal and the dark-current detection signal pass through their respective different signal paths including switches. Further, when different switches are turned on/off, they cause noises having waveforms different from one another due to process variations among them and the like. As a result, in the image pickup device disclosed in Japanese Unexamined Patent Application Publication No. 2009-253930, noises having different waveforms are superimposed on the photocurrent detection signal and the dark-current detection signal. These noises remain as remaining noises when a difference signal between the photocurrent detection signal and the dark-current detection signal is generated. That is, in the image pickup device disclosed in Japanese Unexamined Patent Application Publication No. 2009-253930, there is a problem that image quality could deteriorate due to the remaining noises.

Other objects and novel features will be more apparent from the following description in the specification and the accompanying drawings.

According to one embodiment, an image pickup device includes: a first sampling-and-holding circuit configured to sample a signal output from a pixel circuit; a buffer circuit configured to amplify a signal held in the first sampling-and-holding circuit; and a second sampling-and-holding circuit configured to sample a signal output from the buffer circuit, in which a digital value corresponding to a signal output from the pixel circuit is obtained by passing the signal output from the pixel circuit through the first sampling-and-holding circuit, the buffer circuit, and the second sampling-and-holding circuit in this order, and thereby transmitting the signal output from the pixel circuit to an analog/digital conversion circuit.

According to the above-described embodiment, it is possible to improve image quality of an image generated from a digital value obtained from an image pickup device.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a camera system including an image pickup device according to a first embodiment;

FIG. 2 is a schematic diagram of a floor layout of the image pickup device according to the first embodiment;

FIG. 3 is a circuit diagram of a pixel circuit, a pixel current source, and an amplification circuit of the image pickup device according to the first embodiment;

FIG. 4 is a block diagram of an AD conversion circuit of the image pickup device according to the first embodiment;

FIG. 5 is a circuit diagram of a timing control circuit of the image pickup device according to the first embodiment;

FIG. 6 is a circuit diagram showing a first example of a preceding sampling-and-holding circuit, a buffer circuit, and a succeeding sampling-and-holding circuit of image pickup device according to the first embodiment;

FIG. 7 is a timing chart for briefly explaining a pixel reading operation performed by the image pickup device according to the first embodiment;

FIG. 8 is a timing chart for explaining details of the pixel reading operation performed by the image pickup device according to the first embodiment;

FIG. 9 is a circuit diagram showing a second example of a preceding sampling-and-holding circuit, a buffer circuit, and a succeeding sampling-and-holding circuit of the image pickup device according to the first embodiment;

FIG. 10 is a circuit diagram showing a third example of a preceding sampling-and-holding circuit, a buffer circuit, and a succeeding sampling-and-holding circuit of the image pickup device according to the first embodiment;

FIG. 11 is a circuit diagram of a pixel circuit, a pixel current source, and an amplification circuit of an image pickup device according to a second embodiment;

FIG. 12 is a timing chart for briefly explaining a pixel reading operation performed by the image pickup device according to the second embodiment;

FIG. 13 is a timing chart for explaining details of the pixel reading operation performed by the image pickup device according to the second embodiment;

FIG. 14 is a circuit diagram of a pixel circuit, a pixel current source, and an amplification circuit of an image pickup device according to a third embodiment;

FIG. 15 is a circuit diagram of a pixel circuit, a pixel current source, and an amplification circuit of an image pickup device according to a fourth embodiment;

FIG. 16 is a timing chart for explaining details of the pixel reading operation performed by the image pickup device according to the fourth embodiment;

FIG. 17 is a circuit diagram of a pixel circuit, a pixel current source, and an amplification circuit of an image pickup device according to a fifth embodiment;

FIG. 18 is a timing chart for explaining details of the pixel reading operation performed by the image pickup device according to the fifth embodiment;

FIG. 19 is a circuit diagram of a pixel circuit, a pixel current source, and an amplification circuit of an image pickup device according to a sixth embodiment;

FIG. 20 is a circuit diagram of a pixel circuit, a pixel current source, and an amplification circuit of an image pickup device according to a seventh embodiment; and

FIG. 21 is a timing chart for explaining details of the pixel reading operation performed by the image pickup device according to the seventh embodiment.

### DETAILED DESCRIPTION

### First Embodiment

For clarifying the explanation, the following descriptions and the drawings may be partially omitted and simplified as appropriate. Further, the same symbols are assigned to the same components throughout the drawings and duplicated explanations are omitted as required.

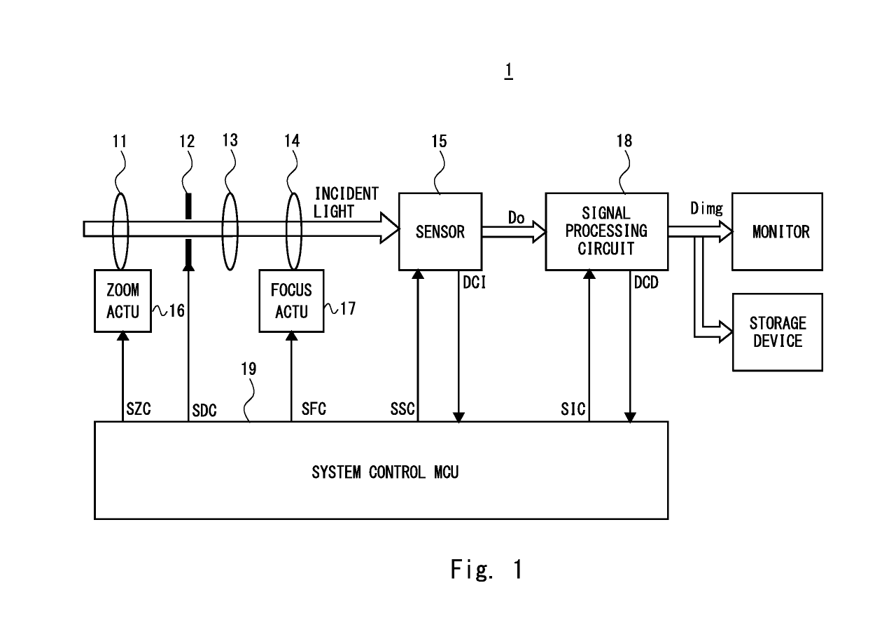

FIG. 1 shows a block diagram of a camera system 1 according to a first embodiment. As shown in FIG. 1, the camera system 1 includes a zoom lens 11, a diaphragm mechanism (or an aperture mechanism) 12, a fixed lens 13, a focus lens 14, an image pickup device 15, a zoom lens actuator 16, a focus lens actuator 17, a signal processing circuit 18, a system control MCU 19, a monitor, and a storage device. Note that the monitor and the storage device are used to check and store an image shot by the camera system 1, and may be disposed in a separate system different from the camera system 1.

The zoom lens 11, the diaphragm mechanism 12, the fixed lens 13, and the focus lens 14 form a group of lenses (hereinafter referred to as a “lens group”) of the camera system 1. The position of the zoom lens 11 is changed by the zoom lens actuator 16. The position of the focus lens 14 is changed by the focus lens actuator 17. Further, in the camera system 1, a zooming magnification and a focus are changed by moving lenses by using various actuators and the amount of incident light is changed by operating the diaphragm mechanism 12.

The zoom lens actuator 16 moves the zoom lens 11 based on a zoom control signal SZC output by the system control MCU 19. The focus lens actuator 17 moves the focus lens 14 based on a focus control signal SFC output by the system control MCU 19. The diaphragm mechanism 12 adjusts the aperture level according to a diaphragm control signal SDC output by the system control MCU 19.

The image pickup device 15 includes, for example, light-receiving elements such as photodiodes, and converts light-receiving pixel information obtained from these light-receiving elements into digital values and outputs them as image information Do. Further, the image pickup device 15 analyzes the image information Do, which the image pickup device 15 outputs as described above, and outputs image feature information DCI representing a feature (s) of the image information Do. This image feature information DCI includes two images acquired in an autofocus process (which is described later). Further, the image pickup device 15 performs gain control for each pixel of the image information Do, exposure control for the image information. Do, and HDR (High Dynamic Range) control for the image information Do based on a sensor control signal SSC supplied from a module control MCU 18. Details of the image pickup device 15 are described later.

The signal processing circuit 18 performs image processing such as an image correction for the image information Do received from the image pickup device 15 and outputs the resultant image information as image data Dimg. Further, the signal processing circuit 18 analyzes the received image information Do and outputs color space information DCD. The color space information DCD includes, for example, luminance information and color information of the image information Do.

The system control MCU controls the focus of the lens group based on the image feature information DCI output from the image pickup device 15. More specifically, the system control MCU 19 controls the focus of the lens group by outputting a focus control signal SFC to the focus lens actuator 17. The system control MCU 19 adjusts the aperture level of the diaphragm mechanism 12 by outputting a diaphragm control signal SDC to the diaphragm mechanism 12. Further, the system control MCU 19 generates a zoom control signal SZC according to an externally-supplied zoom instruction and controls the zooming magnification of the lens group by outputting the zoom control signal SZC to the zoom lens actuator 16.

More specifically, the focus is shifted by moving the zoom lens 11 by using the zoom lens actuator 16. Therefore, the system control MCU 19 calculates a positional phase difference between two object images based on the two images included in the image feature information DCI obtained from the image pickup device 15 and calculates an amount of defocus of the lens group based on the calculated positional phase difference. The system control MCU 19 automatically obtains a correct focus according to this defocus amount. The above-described process is the autofocus control.

Further, the system control MCU 19 calculates an exposure control value indicating an exposure setting for the image pickup device 15 based on the luminance information included in the color space information DCD output from the signal processing circuit 18 and controls the exposure setting and a gain setting of the image pickup device 15 so that the luminance information included in the color space information DCD output from the signal processing circuit 18 becomes closer to the exposure control value. Note that the system control MCU 19 may calculate a control value for the diaphragm mechanism 12 when the exposure is changed.

Further, the system control MCU 19 outputs a color space control signal SIC for adjusting the luminance or the color of the image data Dimg according to an instruction from a user. Note that the system control MCU 19 generates the color space control signal SIC based on a difference between the color space information DCD acquired from the signal processing circuit 18 and information provided by the user.

One of the features of the camera system 1 according to the first embodiment lies in its control method that is performed when pixel information is read from the photodiode in the sensor 15. Therefore, the image pickup device 15 is explained hereinafter in a more detailed manner.

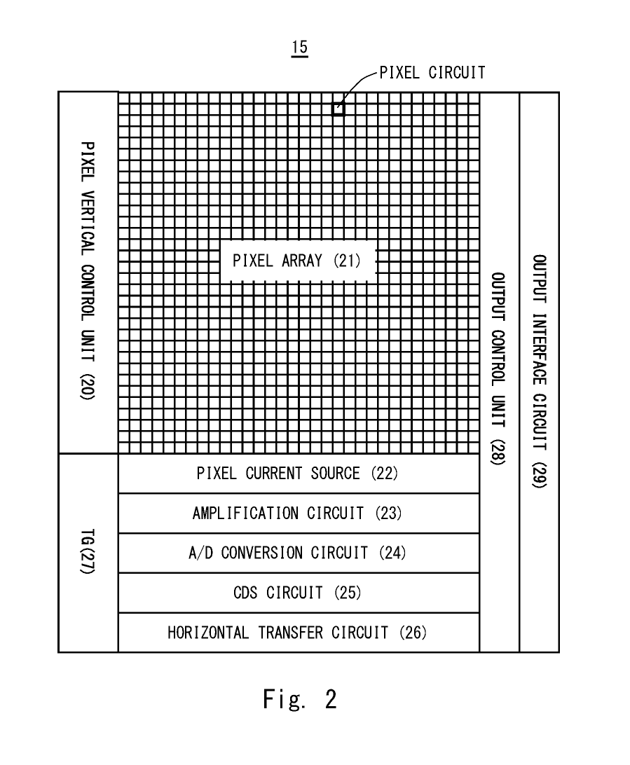

FIG. 2 shows a schematic diagram of a part of a floor layout of the image pickup device 15 according to the first embodiment. FIG. 2 shows only a part of the floor layout of the image pickup device 15 in which a pixel vertical control unit 20, a pixel array 21, a pixel current source 22, an amplification circuit 23, an analog/digital conversion circuit 24, a pixel value generation. circuit (e.g., a CDS (Correlated Double Sampling) circuit) 25, a horizontal transfer circuit 26, a timing generator 27, an output control unit 28, and an output interface 29 are arranged.

The pixel vertical control unit 20 controls operations performed by pixel circuits, which are arranged in a lattice pattern in the pixel array 21, on a row-by-row basis. The pixel current source 22 includes current sources each of which is provided for a respective one of the columns of the pixel circuits arranged in the pixel array 21. The amplification circuit 23 amplifies a signal read from the pixel circuit and adjusts its gain. The analog/digital conversion circuit 24 converts the signal, whose gain has been adjusted by the amplification circuit 23, into a digital value. The CDS circuit 25 outputs a difference between a dark level value corresponding to a dark level signal, which is obtained when a floating diffusion in the pixel circuit is reset, and a pixel value corresponding to a signal level of an image pickup signal, which changes according to an amount of received light and is output by the pixel circuit, as a picture-element value. Further, the picture-element value output from the CDS circuit 25 becomes pixel information. Noises superimposed on the image pickup signal are removed by the CDS circuit 25. The horizontal transfer circuit 26 transfers the pixel information, from which noises have been removed by the CDS circuit 25, to the output control unit 28 in order starting from the pixel circuit closest to the output control unit 28. The timing generator 27 controls timings at which the pixel vertical control unit 20, the pixel current source 22, the amplification circuit 23, the AD conversion circuit 24, and the CDS circuit 25 operate. The output control unit 28 outputs the pixel information transferred by the horizontal transfer circuit 26 to the output interface 29. The output interface 29 is an output interface circuit of the image pickup device 15.

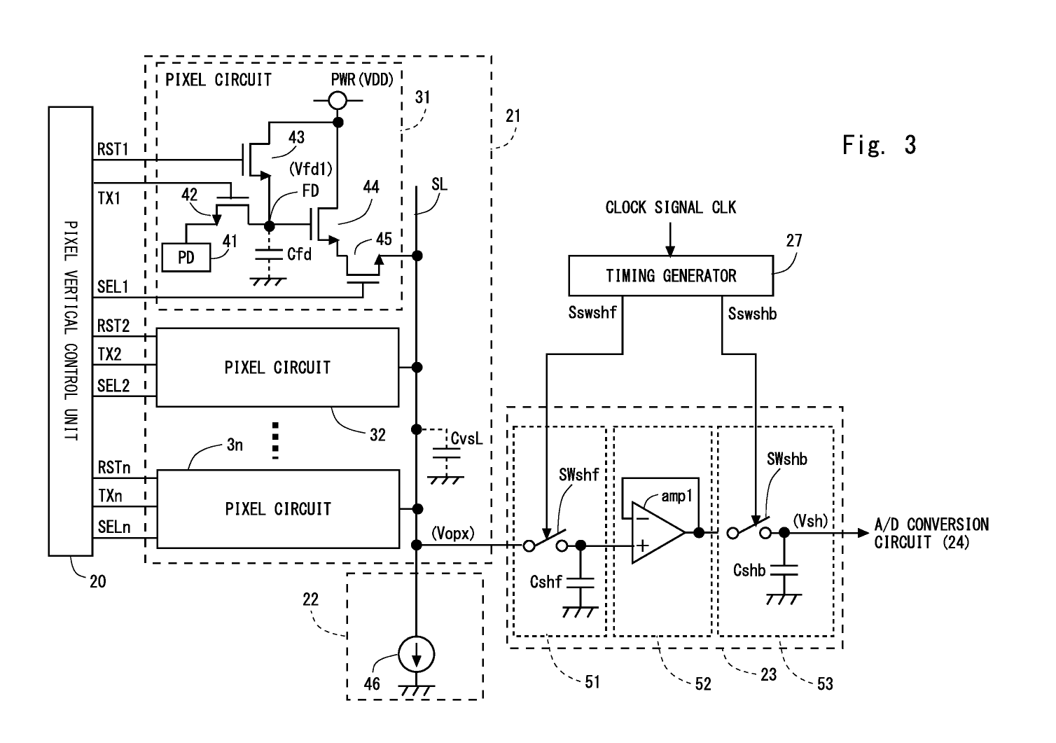

One of the features of the image pickup device according to the first embodiment lies in the amplification circuit 23. Therefore, the amplification circuit 23 is explained hereinafter in a more detailed manner. FIG. 3 shows a circuit diagram of the pixel array 21, the pixel current source 22, and the amplification circuit 23 according to the first embodiment. FIG. 3 shows the pixel vertical control unit 20 and a timing control circuit (e.g., the timing generator 27) for explaining a control signal provided to each component of the pixel circuit and control signals provided to the pixel current source 22 and the amplification circuit 23. Further, FIG. 3 also shows the analog/digital conversion circuit 24, which is disposed behind the amplification circuit 23, for explaining an overview of the circuits. Note that FIG. 3 shows a circuit for one pixel column in FIG. 3, parenthesized symbols indicate voltages that are used in the below explanation.

As shown in FIG. 3, in the pixel array 21 according to the first embodiment, n pixel circuits (pixel circuits 31 to 3n in FIG. 3) are provided for one vertical signal line SL. Since the pixel circuits 31 to 3n are identical to each other, only the pixel circuit 31 is shown with its detailed circuit configuration in FIG. 3. The pixel circuit 31 outputs a dark level signal having a signal level corresponding to a predefined reset level and an image pickup signal having a signal level corresponding to an amount of light received by a light receiving element (e.g., a photodiode) at different timings. The pixel circuit 31 includes an optical/electrical conversion element (e.g., a photodiode 41), a transfer transistor 42, a reset transistor 43, an amplification transistor 44, and a selection transistor 45.

The photodiode 41 generates an electric charge according to an amount of light incident on the image pickup device 15. The transfer transistor 42 is an NMOS transistor and reads the electric charge from the photodiode 41. A source of the transfer transistor 42 is connected to the photodiode 41 and a drain thereof is connected to a floating diffusion FD. Further, a read control signal TX1 is supplied to a gate of the transfer transistor 42. The floating diffusion FD accumulates the electric charge read through the transfer transistor 42. The reset transistor 43 is an NMOS transistor and connected between the floating diffusion FD and a power supply line PWR. A reset control signal RST1 is supplied to a gate of the reset transistor 43. The reset transistor 43 is an NMOS transistor and the floating diffusion FD is connected to a gate of the reset transistor 43. Further, a drain of the reset transistor 43 is connected to the power supply line PWR and a source thereof is connected to an output line. Further, the amplification transistor 44 outputs pixel information Vopx having a voltage corresponding to the amount of the electric charge accumulated in the floating diffusion FD. The selection transistor 45 is an NMOS transistor and disposed between the source of the amplification transistor 44 and the vertical signal line SL. Further, a selection signal SETA is supplied to a gate of the selection transistor 45.

Further, a parasitic capacitance CvsL is formed on the vertical signal line SL. This parasitic capacitance CvsL is a wiring capacitance of the vertical signal line SL. The pixel current source 22 is disposed at an end of the vertical signal line SL. The pixel current source 22 includes a switch SWipx and a constant current source 46. The switch SWipx is disposed between the constant current source 46 and the vertical signal line SL. The constant current source 46 draws a constant current from the vertical signal line SL.

The amplification circuit 23 includes a first sampling-and-holding circuit (e.g., a preceding sampling-and-holding circuit 51), a buffer circuit 52, and a second sampling-and-holding circuit (e.g., a succeeding sampling-and-holding circuit 53).

The preceding sampling-and-holding circuit 51 receives a signal output from the pixel circuits 31 to 3n through the vertical signal line SL and samples the received signal. The preceding sampling-and-holding circuit 51 includes a switch SWshf and a capacitor Cshf. The switch SWshf is disposed between an input end for a signal that is input through the vertical signal line SL and an output end that is connected to a succeeding circuit. The capacitor Cshf is disposed between the output end and a ground line. An opened/closed state of the switch SWshf is controlled by a first sampling-and-holding control signal Sswshb output from the timing generator 27.

The buffer circuit 52 amplifies a signal held in the first sampling-and-holding circuit. More specifically, the buffer circuit 52 transmits a voltage value held in the capacitor Cshf to the succeeding sampling-and-holding circuit 53 disposed behind the buffer circuit 52 while preventing an electric charge held in the capacitor Cshf from flowing out therefrom.

The succeeding sampling-and-holding circuit 53 samples a signal output from the buffer circuit 52. The succeeding sampling-and-holding circuit 53 includes a switch SWshb and a capacitor Cshb. The switch SWshb is disposed between a signal input end to which an output terminal of the buffer circuit 52 is connected and an output end which is connected to a succeeding circuit. The capacitor Cshb is disposed between the output end and the ground line. An opened/closed state of the switch SWshb is controlled by a second sampling-and-holding control signal Sswshb output from the timing generator 27.

The analog/digital conversion circuit 24 generates a digital value corresponding to the signal held in the second sampling-and-holding circuit 53. The timing generator 27 controls sampling operations and holding operations performed by the preceding sampling-and-holding circuit 51 and the succeeding sampling-and-holding circuit 53. The timing generator 27 outputs the first and second sampling-and-holding control signals Sswshf and Sswshb as signals for controlling the sampling operations and the holding operation. Note that FIG. 3 shows only a part of the timing generator 27 that outputs the first and second sampling-and-holding control signals Sswshf and Sswshb.

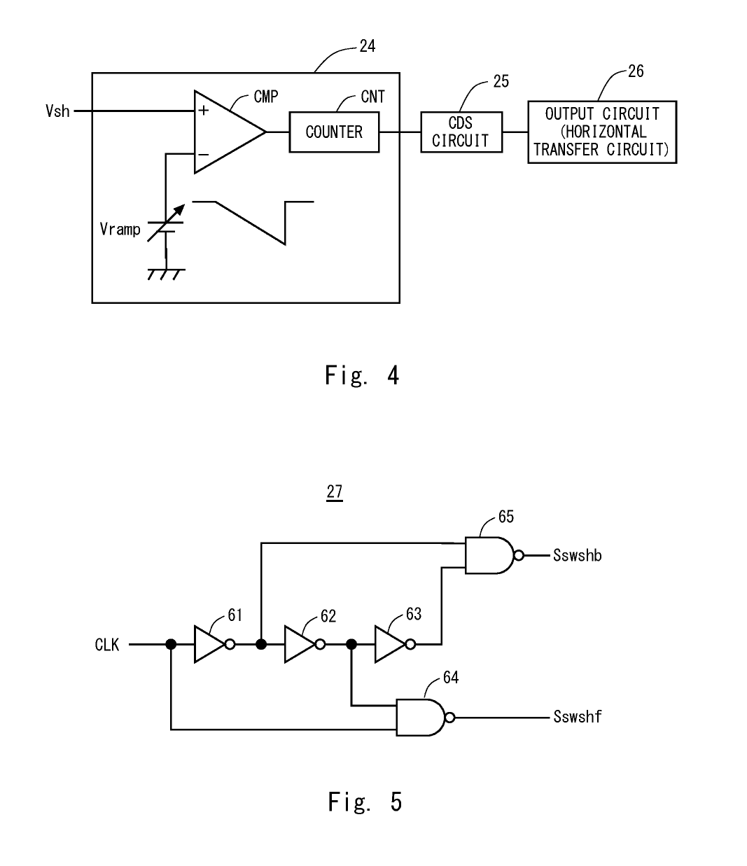

Note that FIG. 4 shows a block diagram of the analog/digital conversion circuit 24 according to the first embodiment. As shown in FIG. 4, the analog/digital conversion circuit 24 includes a ramp signal generation circuit Vramp, a comparator CMP, and a counter CNT. In the analog/digital conversion circuit 24, the ramp signal generation circuit Vramp generates a ramp signal whose voltage decreases from a predetermined voltage value with time. Further, the comparator CMP compares a hold signal Vsh output from the succeeding sampling-and-holding circuit 53 with the ramp signal, and the counter CNT counts a time period from a timing at which the voltage of the ramp signal starts changing to when an output of the comparator CMP is reversed. Further, this count value becomes a dark level value or a pixel value.

Further, FIG. 4 shows the CDS circuit 25 and the output circuit 26 disposed behind the analog/digital conversion circuit 24. The CDS circuit 25 calculates a difference between the dark level value and the pixel value and outputs the calculated value as an output value acquired in the pixel. The output circuit 26 transmits the output value output from the CDS circuit 25 to a succeeding circuit.

The timing generator 27 and the amplification circuit 23 are explained hereinafter in a more detailed manner. Firstly, FIG. 5 shows a circuit diagram of the timing generator 27 of the image pickup device according to the first embodiment. As shown in FIG. 5, the timing generator 27 includes inverters 61 to 63 and NAND circuits 64 and 65.

The inverter 61 receives a clock signal CLK, reverses the input clock signal, and outputs the reversed clock signal. The inverter 62, which is disposed behind the inverter 61, further reverses the clock signal CLK output from the inverter 61 and outputs the reversed clock signal CLK. The inverter 63, which is disposed behind the inverter 62, further reverses the clock signal CLK output from the inverter 62 and outputs the reversed clock signal CLK.

The NAND circuit 64 calculates a reversed logical sum of the clock signal CLK input to the inverter 61 and the clock signal CLK output from the inverter 62 and outputs the calculated reversed logical sum as a first sampling-and-holding control signal Sswshf. The NAND circuit 65 calculates a reversed logical sum of the clock signal CLK output from the inverter 61 and the clock signal CLK output from the inverter 63 and outputs the calculated reversed logical sum as a second sampling-and-holding control signal Sswshb.

By having the above-described circuit configuration, the timing generator 27 controls the preceding and succeeding sampling-and-holding circuits 51 and 53 so that sampling operations and holding operations are alternately performed at successive timings.

More specifically, the timing generator 27 controls the preceding and succeeding sampling-and-holding circuits 51 and 53 so that: a sampling operation by the preceding sampling-and-holding circuit 51 and a sampling operation by the succeeding sampling-and-holding circuit 53 for a dark level signal are performed successively at different timings; a sampling operation for an image pickup signal by the preceding sampling-and-holding circuit 51 is performed during a period in which the succeeding sampling-and-holding circuit 53 holds the dark level signal; and a sampling operation for the image pickup signal by the succeeding sampling-and-holding circuit 53 is performed successively at a different timing later than the sampling operation performed by the preceding sampling-and-holding circuit 51.

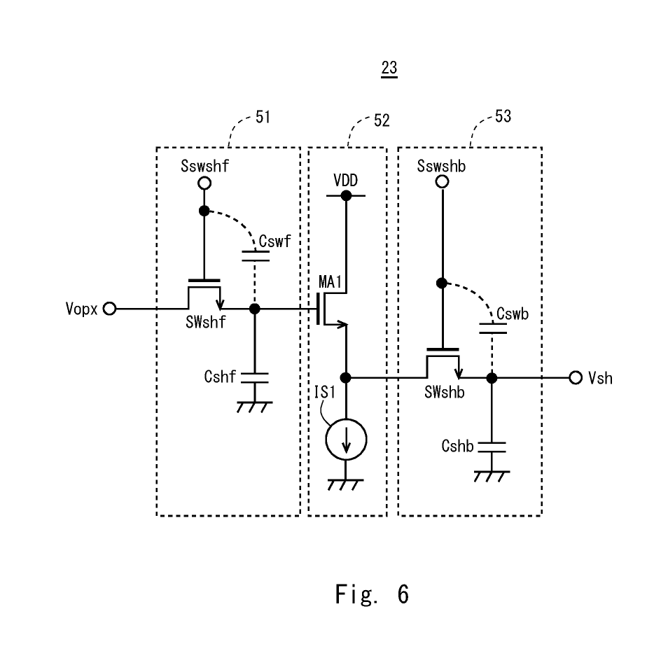

Next, FIG. 6 shows a circuit diagram showing a first example of the preceding sampling-and-holding circuit 51, the buffer circuit 52, and the succeeding sampling-and-holding circuit 53 of the image pickup device according to the first embodiment. As shown in FIG. 6, the preceding sampling-and-holding circuit 51 incudes a switch transistor corresponding to the switch SWshf and a capacitor Cshf. The switch SWshf is an NMOS transistor and its drain is connected to the vertical signal line SL. Further, a source of the switch SWshf is connected to the buffer circuit 52. One end of the capacitor Cshf is connected to the source of the switch SWshf and the other end thereof is connected to a ground line. Pixel information Vopx is input to the drain of the switch SWshf. This pixel information Vopx becomes a dark level signal or an image pickup signal according to the operation timing of the pixel circuit 31.

The buffer circuit 52 includes an amplification transistor MA1 and a current source IS1. A voltage held in the capacitor Cshf of the preceding sampling-and-holding circuit 51 is input to a gate of the amplification transistor MA1. A drain of the amplification transistor MA1 is connected to a power supply line. A source of the amplification transistor MA1 is connected to the ground line through the current source IS1. The current source IS1 is a constant current source. Further, the source of the amplification transistor MA1 serves as an output terminal of the buffer circuit 52. That is, in the buffer circuit 52, the amplification transistor MA1 forms a source follower circuit.

The succeeding sampling-and-holding circuit 53 incudes a switch transistor corresponding to the switch SWshb and a capacitor Cshb. The switch SWshb is an NMOS transistor and its drain is connected to the output terminal of the buffer circuit 52. Further, a source of the switch SWshb is connected to the analog/digital conversion circuit 24 disposed behind the succeeding sampling-and-holding circuit 53. One end of the capacitor Cshb is connected to the source of the switch SWshf and the other end thereof is connected to the ground line. An output signal from the buffer circuit 52 is input to a drain of the switch SWshb. The buffer circuit 52 outputs a voltage that is generated based on an electric charge held in the capacitor Cshb as a hold signal Vsh. A voltage level of this hold signal Vsh becomes a voltage level of a dark level signal or a voltage level of an image pickup signal according to the operation timing of the pixel circuit 31.

It should be noted that a parasitic capacitance Cswf exists between the gate and the source of the switch SWshf of the preceding sampling-and-holding circuit 51. Further, a parasitic capacitance Cswb exists between the gate and the source of the switch SWshb of the succeeding sampling-and-holding circuit 53. Opened/closed states of these two switches are controlled by rectangular waves input to their gates. Therefore, when the opened/closed states of these switches are changed, noises are superimposed on the signals held in the respective sampling-and-holding circuits due to the parasitic capacitances Cshf and Cshb. In the image pickup device 15 according to the first embodiment, since the dark level signal and the image pickup signal are transmitted to the analog/digital conversion circuit 24 through the same path including the amplification circuit 23, the noises that are superimposed on the dark level signal and the image pickup signal have the same waveforms. Further, in the image pickup device 15 according to the first embodiment, by performing calculation in which a difference between a dark level value corresponding to a dark level signal and a pixel value corresponding to a signal level of an image pickup signal becomes a picture-element value in the process that is performed in the circuit located behind the analog/digital conversion circuit 24, noises that are caused in the switches SWshf and SWshb can be cancelled out.

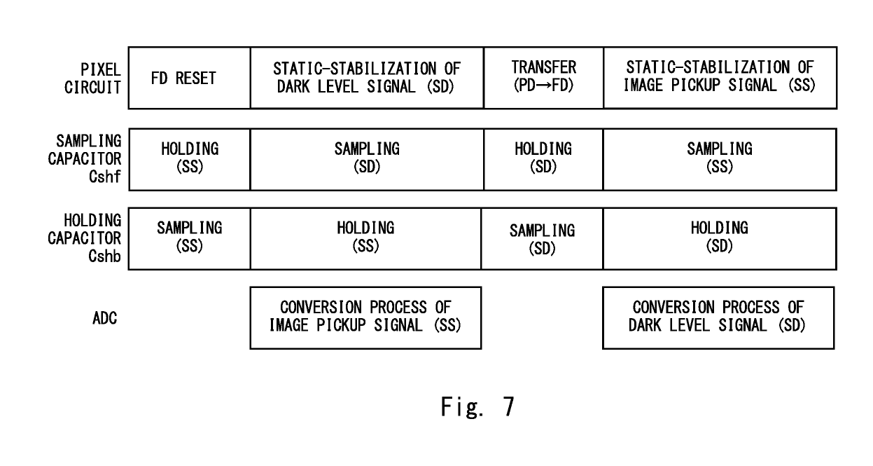

Accordingly, an operation performed by the image pickup device 15 according to the first embodiment is explained. FIG. 7 is a timing chart for briefly explaining a pixel reading operation performed by the image pickup device according to the first embodiment. The timing chart shown in FIG. 7 is for showing a process flow. Therefore, the actual length of each process and the like are not taken into account in the timing chart. Further, the operation shown in FIG. 7 is an operation for reading pixel information corresponding to one pixel from a pixel circuit.

As shown in FIG. 7, in the image pickup device 15 according to the first embodiment, the pixel circuit outputs an image pickup signal through four operations. A first operation is a reset process for a floating diffusion (an FD reset). A second operation is a dark level signal statically stabilizing process for statically stabilizing voltage levels of the vertical signal line SL and the capacitor Cshf to a voltage level of a dark level signal that is generated by the reset process. A third operation is a transfer process for transferring an electric charge from a photodiode to the floating diffusion. A fourth operation is an image pickup signal statically stabilizing process for statically stabilizing voltage levels of the vertical signal line SL and the capacitor Cshf to a voltage level of an image pickup signal that is generated by the transfer process.

In the image pickup device 15 according to the first embodiment, a sampling operation and a holding operation performed by the preceding sampling-and-holding circuit 51 and the buffer circuit 52 are controlled according to the above-described operation performed by the pixel circuit. Specifically, operations that are performed by the preceding sampling-and-holding circuit 51 and the buffer circuit 52 when the pixel circuit is performing the first operation are as follows. In this period, the preceding sampling-and-holding circuit 51 turns off the switch SWshf and thereby holds an image pickup signal that was sampled in a period preceding this period. Further, the succeeding sampling-and-holding circuit 53 turns on the switch SWshb and thereby samples the image pickup signal held by the preceding sampling-and-holding circuit 51. Further, in the period in which the succeeding sampling-and-holding circuit 53 is performing the sampling operation, the hold signal Vsh output from the succeeding sampling-and-holding circuit 53 changes. Therefore, the analog/digital conversion circuit 24 does not perform a conversion process.

Further, operations that are performed by the preceding sampling-and-holding circuit 51 and the buffer circuit 52 when the pixel circuit is performing the second operation are as follows. In this period, the voltage of the vertical signal line SL changes to a voltage level of a dark level signal. Therefore, in this period, the preceding sampling-and-holding circuit 51 turns on the switch SWshf and samples the dark level signal. Further, the succeeding sampling-and-holding circuit 53 turns off the switch SWshb and holds the image pickup signal that was sampled in a period preceding this period. Further, in the period in which the succeeding sampling-and-holding circuit 53 is performing the holding operation, the hold signal Vsh output from the succeeding sampling-and-holding circuit 53 is stable. Therefore, the analog/digital conversion circuit 24 performs a conversion process for the image pickup signal held in the succeeding sampling-and-holding circuit 53.

Further, operations that are performed by the preceding sampling-and-holding circuit 51 and the buffer circuit 52 when the pixel circuit is performing the third operation are as follows. In this period, the preceding sampling-and-holding circuit 51 turns off the switch SWshf and thereby holds a dark level signal that was sampled in a period preceding this period. Further, the succeeding sampling-and-holding circuit 53 turns on the switch SWshb and thereby samples the dark level signal held by the preceding sampling-and-holding circuit 51. Further, in the period in which the succeeding sampling-and-holding circuit 53 is performing the sampling operation, the hold signal Vsh output from the succeeding sampling-and-holding circuit 53 changes. Therefore, the analog/digital conversion circuit 24 does not perform a conversion process.

Further, operations that are performed by the preceding sampling-and-holding circuit 51 and the buffer circuit 52 when the pixel circuit is performing the fourth operation are as follows. In this period, the voltage of the vertical signal line SL changes to a voltage level of an image pickup signal. Therefore, in this period, the preceding sampling-and-holding circuit 51 turns on the switch SWshf and samples the image pickup signal. Further, the succeeding sampling-and-holding circuit 53 turns off the switch SWshb and holds the dark level signal that was sampled in a period preceding this period. Further, in the period in which the succeeding sampling-and-holding circuit 53 is performing the holding operation, the hold signal Vsh output from the succeeding sampling-and-holding circuit 53 is stable. Therefore, the analog/digital. conversion circuit 24 performs a conversion process for the dark level signal held in the succeeding sampling-and-holding circuit 53.

That is, in the image pickup device 15 according to the first embodiment, the preceding and succeeding sampling-and-holding circuits 51 and 53 repeatedly and alternately perform sampling operations and holding operations. In this way, the image pickup device 15 according to the first embodiment performs an analog/digital conversion process for a signal held in the succeeding sampling-and-holding circuit 53 and a sampling operation for a signal performed by the preceding sampling-and-holding circuit 51 in parallel.

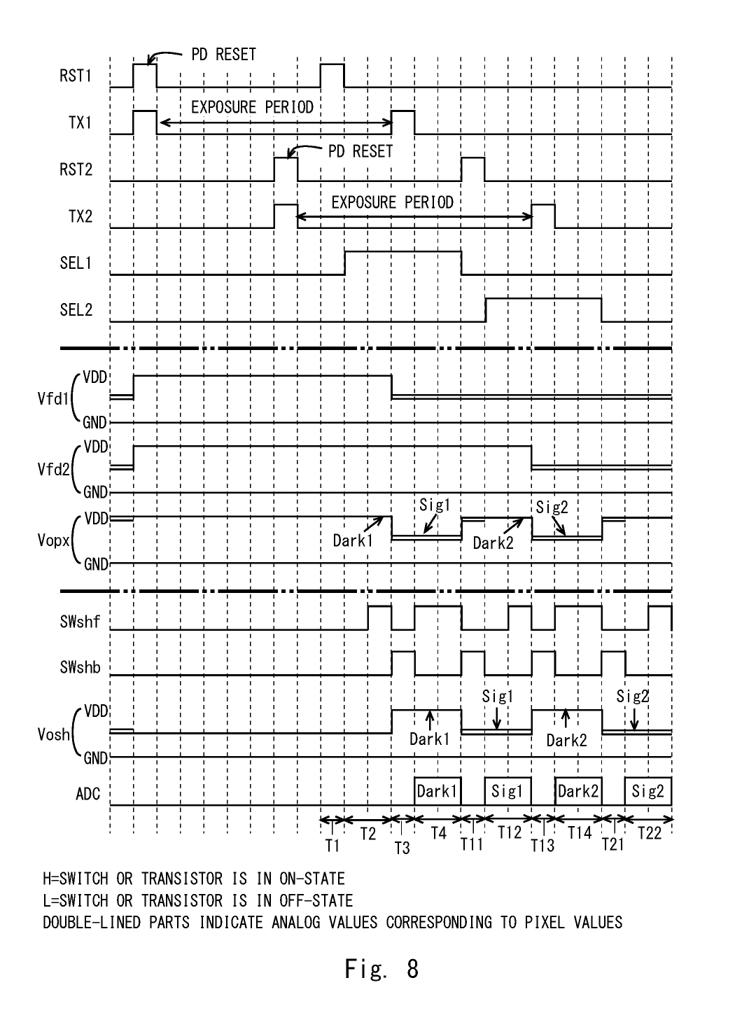

Next, the operation performed by the image pickup device 15 according to the first embodiment is explained in a more detailed manner. Therefore, FIG. 8 shows a timing chart for explaining details of the pixel reading operation performed by the image pickup device according to the first embodiment. FIG. 8 shows an example of the operation that is performed by the image pickup device 15 when image pickup signals are read from the pixel circuits 31 and 32.

As shown in FIG. 8, in the image pickup device 15 according to the first embodiment, firstly, a PD reset process for setting the voltage of the photodiode included in the pixel circuit to a reset voltage is performed in the order of the reading. In the example shown in FIG. 8, a period in which the reset transistor 43 and the transfer transistor 42 are both turned on at the same time is the period in which the PD resetting is performed. When this PD reset process is finished, the reset transistor 43 and the transfer transistor 42 are turned off and an exposure process for each photodiode starts.

Then, during the photodiode exposure period, a reset process for a floating diffusion (hereinafter referred to as an FD reset process) is performed for each pixel circuit at a different timing by controlling the reset transistor 43 into an on-state and the transfer transistor 42 into an off-state in the pixel circuit. After the FD reset process, the pixel circuit first outputs a dark level signal having a voltage level corresponding to the reset voltage to the vertical signal line SL by turning on the selection transistor 45. Further, after outputting the dark level signal, the pixel circuit outputs an image pickup signal to the vertical signal line SL by turning on the transfer transistor 42 while maintaining the selection transistor 45 in the on-state.

Note that in the image pickup device 15 according to the first embodiment, in periods T11 to T14 (and a period T22 and the subsequent periods), which are after the selection transistor 45 of the pixel circuit 31 was turned on, a dark level value corresponding to a dark level signal and a pixel value corresponding to a signal level of an image pickup signal are obtained by performing the first to fourth operations explained above with reference to FIG. 7. Note that FIG. 7 shows an example in which a reading process starts from the pixel circuit 31 disposed in the first row among the pixel circuits arranged in a lattice pattern. The processes in the periods T1 to T4, which correspond to the reading process for the first row, slightly differ from the processes performed in other periods.

Specifically, when a reading process for the pixel circuit 31 is performed, no signal is sampled or held in the preceding and succeeding sampling-and-holding circuits 51 and 53. Therefore, in the periods T1 to T4, the sampling operation and the holding operation performed by the preceding and succeeding sampling-and-holding circuits 51 and 53 may not be performed in parallel.

In the period T1, a reset process for the floating diffusion of the pixel circuit 31 is performed. At this point, there is no sampled signal or held signal the preceding and succeeding sampling-and-holding circuits 51 and 53.

In the period T2, the voltage levels of the vertical signal line SL and the capacitor Cshb are statically stabilized to a voltage level of a dark level signal Dark1 output by the pixel circuit 31 by controlling the selection transistor 45 and the switch SWshf of the pixel circuit 31 into an on-state and controlling the switch SWshb into an off-state. That is, in the period T2, sampling of the dark level signal Dark1 into the capacitor Cshf is performed.

In the period T3, the capacitor Cshb samples the signal level of the dark level signal Dark1 held in the capacitor Cshb by turning off the switch SWshf and turning on the switch SWshb. Further, in the period T3, the transfer transistor 42 of the pixel circuit 32 is turned on while the selection transistor 45 is maintained in the on-state, so that an image pickup signal Sig1 is output from the pixel circuit 31 to the vertical signal line SL and the vertical signal line SL is statically stabilized to the voltage level of the image pickup signal Sig1.

In the period T4, an analog/digital conversion process is performed for a hold signal Vsh corresponding to the dark level signal Dark1 held in the capacitor Cshb. Further, in the period T4, the image pickup signal Sig1 is sampled into the capacitor Cshf by turning on the switch SWshf and turning off the switch SWshb. Further, the state of the selection transistor 45 of the pixel circuit 31 is changed from the on-state to an off-state at a timing at which the period T4 ends.

An operation performed in a period T11 is the first operation explained above with reference to FIG. 7. In the period T11, a reset process for the floating diffusion of the pixel circuit 32 is performed. Further, in the period T11, the capacitor Cshb samples the signal level of the image pickup signal Sig1 held in the capacitor Cshb by turning off the switch SWshf and turning on the switch SWshb. As a result, the voltage level of the hold signal Vsh output from the succeeding sampling-and-holding circuit 53 becomes the voltage level of the image pickup signal Sig1.

An operation performed in a period T12 is the second operation explained above with reference to FIG. 7. In the period T12, the voltage levels of the vertical signal line SL and the capacitor Cshb are statically stabilized to a voltage level of a dark level signal Dark2 output by the pixel circuit 32 by controlling the selection transistor 45 and the switch SWshf of the pixel circuit 32 into an on-state and controlling the switch SWshb into an off-state. That is, in the period T12, sampling of the dark level signal Dark2 into the capacitor Cshf is performed. Further, in the period T12, since the capacitor Cshb holds the image pickup signal Sig1, an analog/digital conversion process for the image pickup signal Sig1 is performed.

An operation performed in a period T13 is the third operation explained above with reference to FIG. 7. In the period T13, the capacitor Cshb samples the signal level of the dark level signal Dark2 held in the capacitor Cshb by turning off the switch SWshf and turning on the switch SWshb. Further, in the period T13, the transfer transistor 42 of the pixel circuit 32 is turned on while the selection transistor 45 is maintained an the on-state, so that an image pickup signal Sig2 is output from the pixel circuit 32 to the vertical signal line SL and the vertical signal line SL is statically stabilized to the voltage level of the image pickup signal Sig2.

An operation performed in a period T14 is the fourth operation explained above with reference to FIG. 7. In the period T14, an analog/digital conversion process is performed for a hold signal Vsh corresponding to the dark level signal Dark2 held in the capacitor Cshb. Further, in the period T14, the image pickup signal Sig2 is sampled into the capacitor Cshf by turning on the switch SWshf and turning off the switch SWshb. Further, the state of the selection transistor 45 of the pixel circuit 32 is changed from the on-state to an off-state at a timing at which the period T14 ends.

After the period T14, the operations explained in the periods T11 to T14 are repeatedly performed while changing the pixel circuit for which the reading is performed.

As explained above, in the image pickup device 15 according to the first embodiment, the dark level signal and the image pickup signal are transmitted to the analog/digital conversion circuit 24 through the same path including the preceding and succeeding sampling-and-holding circuits 51 and 53. Further, a difference between a dark level value corresponding to a dark level signal and a pixel value corresponding to a signal level of an image pickup signal output from the analog/digital conversion circuit 24 is calculated by the CDS circuit 25 and the calculated value is output as a picture-element value. In this way, the image pickup device 15 according to the first embodiment can cancel out noise components superimposed on the two signals on the signal transmission path and thereby considerably reduce noises in the picture-element value.

Further, in the image pickup device 15 according to the first embodiment, since noise levels of picture-element values for each column are uniformly cancelled out, it is possible to reduce vertical stripe noises that occur in a stationary manner on a screen due to noise level difference among columns. Note that when vertical stripe noises occur, they can be corrected by using a correction circuit or the like. However, since the image pickup device 15 according to the first embodiment can reduce vertical stripe noises by its circuit configuration, there is no need to use such a correction circuit. That is, the image pickup device 15 according to the first embodiment can be implemented without using the correction circuit, thus making it possible to reduce the circuit size.

Further, in the picture-element value reading process in the image pickup device, each of the static-stabilization of the voltage of the vertical signal line SL and the analog/digital conversion process requires a long processing time. In the image pickup device 15 according to the first embodiment, by the signal output from the pixel circuit, the static-stabilization of the vertical signal line SL and the sampling operation of the capacitor Cshf are performed in parallel with the analog/digital conversion process of the signal that was output from the pixel circuit one timing before the signal that is presently output from the pixel circuit. That is, in the image pickup device 15 according to the first embodiment, by performing processes that require long processing times in parallel, the time required to read a picture-element value corresponding to one pixel can be reduced. In recent year, the number of pixels in an image pickup device is increasing. Therefore, the reduction in the time required for a reading process becomes more effective as the number of pixels increases.

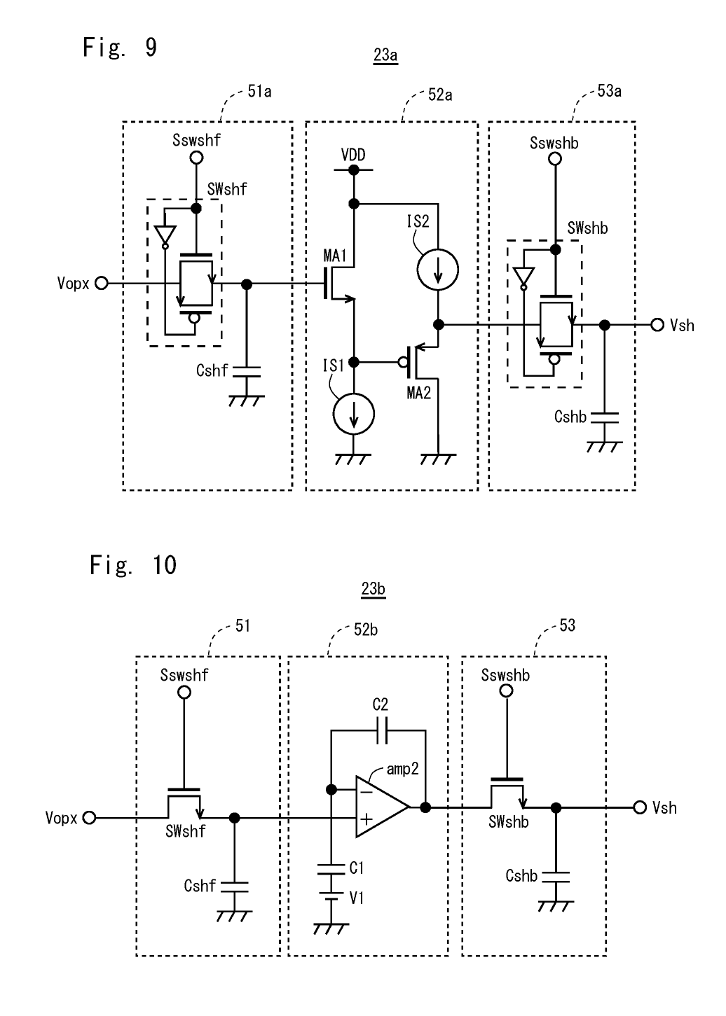

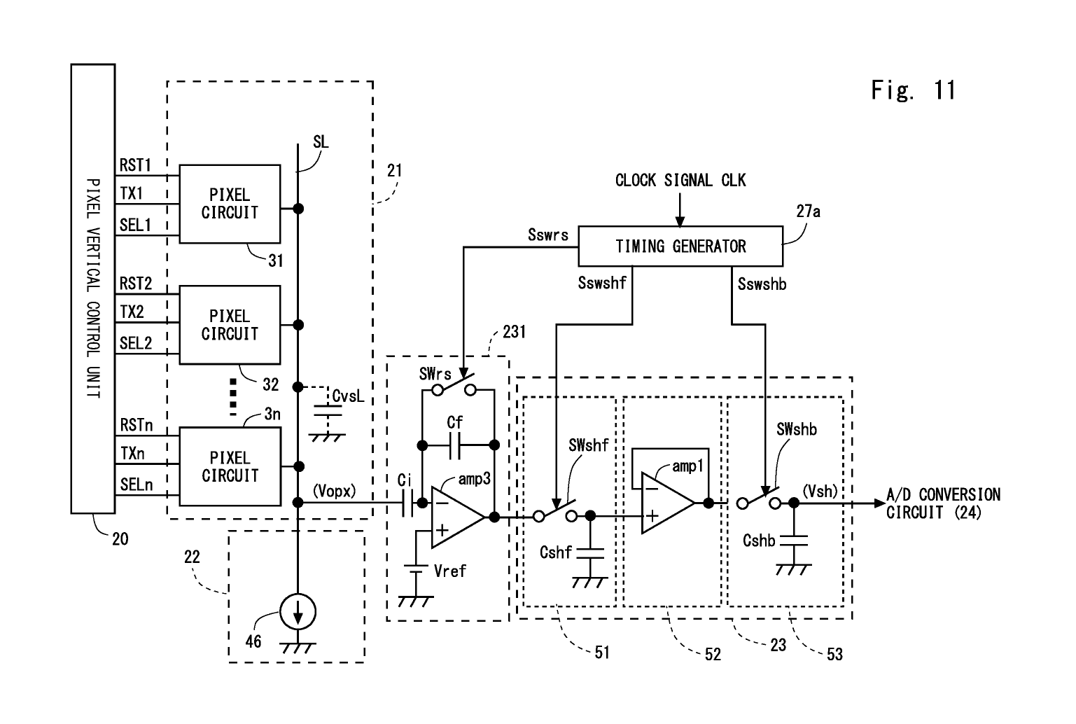

It should be noted that various modified examples are conceivable for the preceding sampling-and-holding circuit 51, the buffer circuit 52, and the succeeding sampling-and-holding circuit 53 explained above with reference to FIG. 6. Therefore, modified examples of these circuits are explained hereinafter. Firstly, FIG. 9 shows a circuit diagram showing a second example of the preceding sampling-and-holding circuit, the buffer circuit, and the succeeding sampling-and-holding circuit of the image pickup device according to the first embodiment.

As shown in FIG. 9, the second example is an amplification circuit 23a, which is a modified example of the amplification circuit 23. The amplification circuit 23a includes a preceding sampling-and-holding circuit 51a, a buffer circuit 52a, and a succeeding sampling-and-holding circuit 53a.

The preceding and succeeding sampling-and-holding circuit 51a and 53a are formed by using transfer switches as the switches SWshf and SWshb, respectively. The buffer circuit 52a is formed by connecting a first source follower circuit in which an NMOS transistor is used as an amplification transistor MA1 and a second source follower circuit in which a PMOS transistor is used as an amplification transistor MA2 in series.

In the amplification circuit 23a according to the second example, another configuration example of the switches SWshf and SWshb is shown. Further, in the amplification circuit 23a, by connecting two source follower circuits in which transistors having different conductive types are used as amplification transistors in series, it is possible to cancel out voltage shifts by the amplification transistors caused in the source follower circuits.

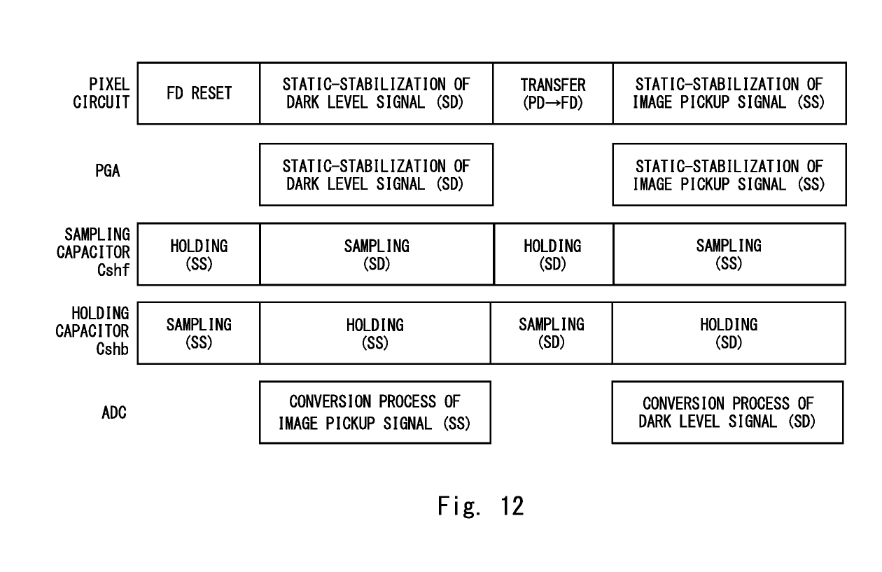

Next, FIG. 10 shows a circuit diagram showing a third example of the preceding sampling-and-holding circuit, the buffer circuit, and the succeeding sampling-and-holding circuit of the image pickup device according to the first embodiment. As shown in FIG. 10, the third example is an amplification circuit 23b, which is a modified example of the amplification circuit 23. The amplification circuit 23b includes a preceding sampling-and-holding circuit 51, a buffer circuit 52b, and a succeeding sampling-and-holding circuit 53.

The buffer circuit 52b is an amplification circuit using a non-inverting amplification circuit whose amplification factor is determined by the ratio between capacitances of capacitors C1 and C2. By using the aforementioned feedback amplifier as the buffer circuit, it is possible to further reduce the error in the voltage level of the signal transmitted from the preceding sampling-and-holding circuit 51 to the succeeding sampling-and-holding circuit 53 compared to the error in the second example.

### Second Embodiment

In a second embodiment, a modified example of the image pickup device 15 according to the first embodiment is explained. Note that in the explanation of the second embodiment, the same symbols as those in the first embodiment, are assigned to the same components as those explained in the first embodiment and their explanations are omitted.

FIG. 11 shows a circuit diagram of a pixel circuit, a pixel current source, and an amplification circuit of an image pickup device according to the second embodiment. As shown in FIG. 11, the image pickup device according to the second embodiment includes an additional variable-gain amplifier 231 disposed between the preceding sampling-and-holding circuit 51 and the vertical signal line SL.

The variable-gain amplifier 231 includes an input capacity Ci, a feedback capacity Cf, an amplifier amp3, a reference voltage source, and a reset switch SWrs. Pixel information Vopx is input to one end of the input capacity Ci and the other end thereof is connected to an inverting input terminal of the amplifier amp3. The feedback capacity Cf is connected between an output terminal of the amplifier amp3 and the inverting input terminal thereof. The reference voltage source is a voltage source that generates a reference voltage Vref and supplies the reference voltage Vref to a non-inverting input terminal of the amplifier amp3. The reset switch SWrs is connected in parallel with the feedback capacity Cf. An opened/closed state of this reset switch SWrs is controlled by a reset switch control signal. Sswrs output from a timing generator 27a. The timing generator 27a is obtained by adding a function of outputting the reset switch control signal Sswrs to the timing generator 27.

The gain of the variable-gain amplifier 231 is changed by changing the ratio between the capacitances of the input capacity Ci and the feedback capacity Cf. Further, for the variable-gain amplifier 231, the ratio between the capacitances of the input capacity Ci and the feedback capacity Cf is changed for each pixel to be read based on an amplification factor that is defined in advance for each pixel to be read. The ratio between the capacitances of the input capacity Ci and the feedback capacity Cf is controlled by an amplification factor control circuit (not shown).

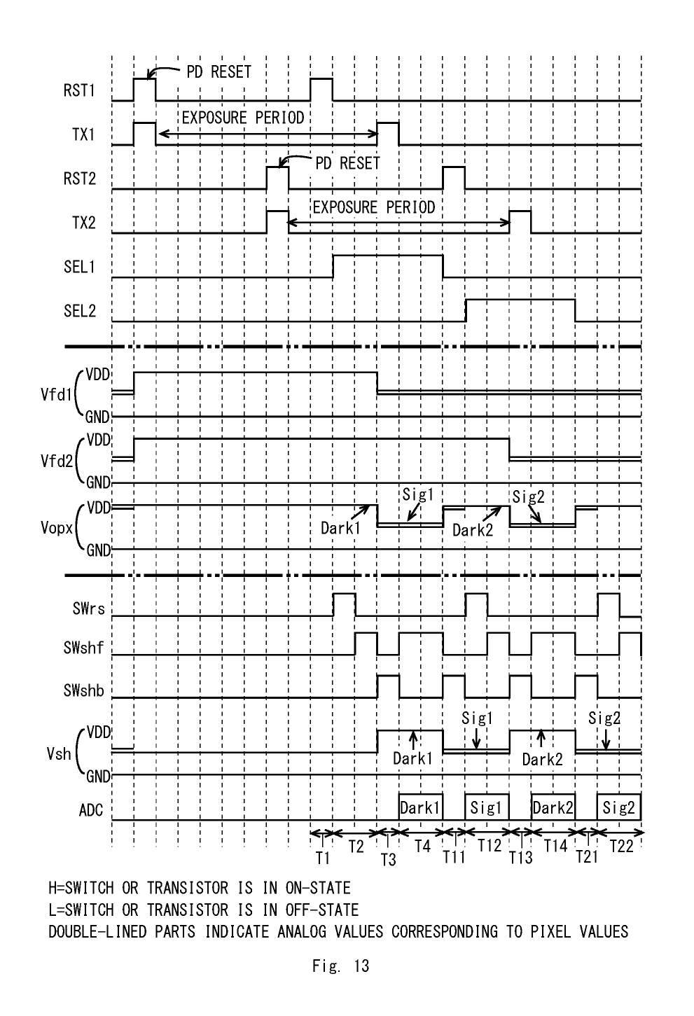

Next, an operation performed by the image pickup device according to the second embodiment is explained. Firstly, FIG. 12 is a timing chart for briefly explaining a pixel reading operation performed by the image pickup device according to the second embodiment. As shown in FIG. 12, the variable-gain amplifier 231 operates at a timing at which the voltage of the vertical signal line SL changes. Specifically, the variable-gain amplifier 231 operates according to a dark level signal statically stabilizing process in which a pixel circuit sets the voltages of the vertical signal line SL and the input capacity Ci of the variable-gain amplifier 231 to a voltage of a dark level signal output by the pixel circuit itself. Further, the variable-gain amplifier 231 operates according to an image pickup signal statically stabilizing process in which the pixel circuit sets the voltages of the vertical signal line SL and the input capacity Ci of the variable-gain amplifier 231 to a voltage of an image pickup signal output by the pixel circuit itself.

Next, FIG. 13 shows a timing chart for explaining details of the pixel reading operation performed by the image pickup device according to the second embodiment. Even when the analog/digital conversion circuit 24 is used, the operations performed by the pixel circuit, the amplification circuit 23, and the like are not changed. However, a reset operation for the variable-gain amplifier 231 is performed by turning on the reset switch SWrs in a period that is after a dark level signal or an image pickup signal starts to be output to the vertical signal line SL and before a sampling operation into the capacitor Cshf starts. This reset operation is a process for setting the electric charge of the feedback capacity Cf to zero and setting the output signal of the variable-gain amplifier 231 to the reference voltage Vref.

In the second embodiment, a signal is supplied to the preceding sampling-and-holding circuit 51 through the variable-gain amplifier 231. In this way, in the second embodiment, it is possible to reduce a fixed pattern noise that is caused due to variations among pixels. Further, by providing the variable-gain amplifier 231, it is possible to provide a signal that is supplied to the preceding sampling-and-holding circuit 51 through the vertical signal line SL to the preceding sampling-and-holding circuit 51 in an amplified state and thereby to reduce variations in sampling operations performed by the preceding sampling-and-holding circuit 51. As a result, the image pickup device according to the second embodiment can reduce random noises that are caused in the preceding sampling-and-holding circuit 51.

### Third Embodiment

In a third embodiment, a modified example of the image pickup device 15 according to the second embodiment is explained. Note that in the explanation of the third embodiment, the same symbols as those in the first and second embodiments are assigned to the same components as those explained in the first and second embodiments and their explanations are omitted.

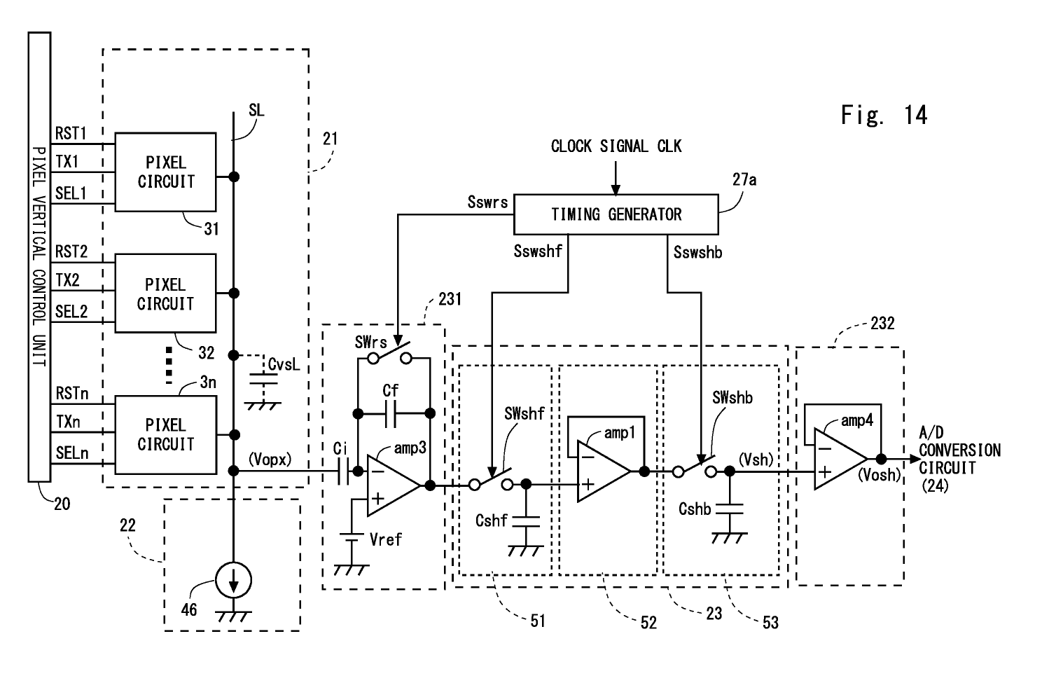

FIG. 14 is a circuit diagram of a pixel circuit, a pixel current source, and an amplification circuit of an image pickup device according to the third embodiment. As shown in FIG. 14, the image pickup device according to the third embodiment is obtained by adding a succeeding buffer circuit 232 in the image pickup device according to the second embodiment. The succeeding buffer circuit 232 is disposed between the succeeding sampling-and-holding circuit 53 and the analog/digital conversion circuit 24. The succeeding buffer circuit 232 is an inverting amplifier formed by using an amplifier amp4.

The operation of the image pickup device according to the third embodiment is the same as that of the image pickup device according to the second embodiment and therefore explanations thereof using a timing chart and the like are omitted. In the image pickup device according to the third embodiment, the output impedance of the succeeding sampling-and-holding circuit 53 is reduced by disposing the succeeding buffer circuit 232. As a result, the image pickup device according to the third embodiment can reduce the effect on the succeeding sampling-and-holding circuit 53 caused by noises that are caused as the analog/digital conversion circuit 24 operates. That is, the image pickup signal according to the third embodiment generates picture-element values having noises lower than the noises in the first and second embodiments and thereby improves the image quality.

### Fourth Embodiment

In a fourth embodiment, a modified example of the pixel circuit according to the first embodiment is explained. Note that in the explanation of the fourth embodiment, the same symbols as those in the first embodiment are assigned to the same components as those explained in the first embodiment and their explanations are omitted.

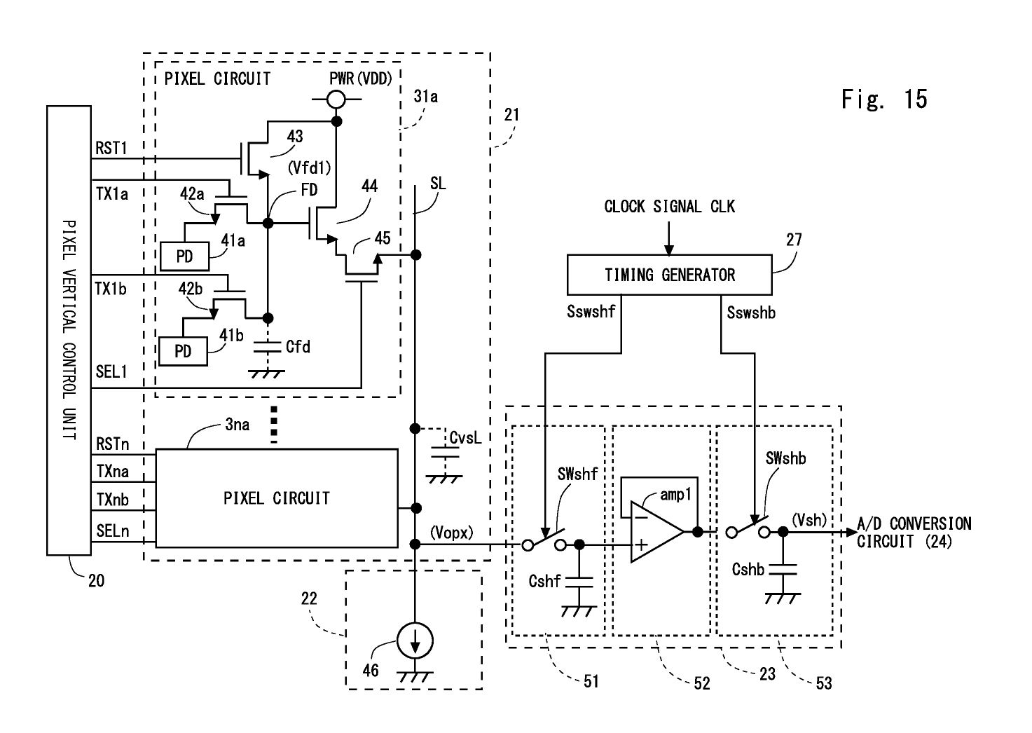

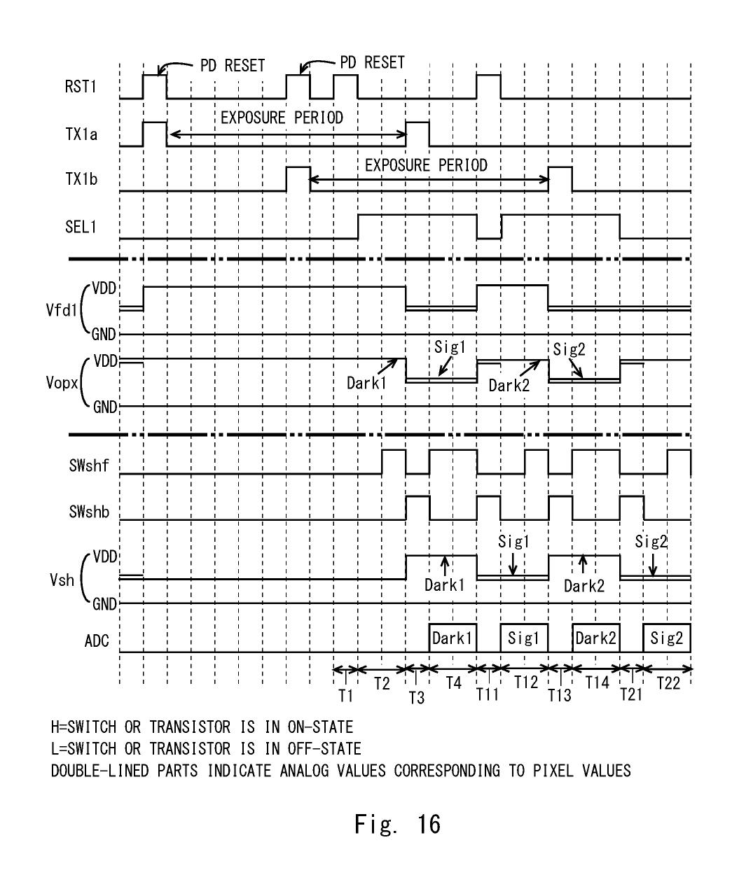

FIG. 15 shows a circuit diagram of a pixel circuit, a pixel current source, and an amplification circuit of an image pickup device according to the fourth embodiment. Note that a pixel array 21 according to the fourth embodiment includes pixel circuits 31a to 3na. However, since the pixel circuits 31a to 3na are identical to each other, only the pixel circuit 31a is shown with its detailed circuit configuration.

As shown in FIG. 15, the pixel circuit 31a according to the fourth embodiment includes two pairs of photodiodes and transfer transistors for one set of a reset transistor 43, an amplification transistor 44, and a selection transistor 45. In the example shown in FIG. 15, the pixel circuit 31a incudes therein photodiodes 41a and 41b, and transfer transistors 42a and 42b.

An operation performed by the image pickup device according to the fourth embodiment is explained hereinafter. Therefore, FIG. 16 shows a timing chart for explaining details of the pixel reading operation performed by the image pickup device according to the fourth embodiment.

As shown in FIG. 16, in the image pickup device according to the fourth embodiment, the operations performed by the amplification circuit 23, the timing generator 27, and the analog/digital conversion circuit 24 are the same as those in the first embodiment. However, control for outputting a signal from a pixel circuit in the fourth embodiment differs from the control in the first embodiment. Therefore, the difference in the method for controlling the pixel circuit is explained.

As shown in FIG. 16, in the pixel circuit according to the fourth embodiment, reset processes for the two photodiodes are performed in a period that is before pixel signals are taken from the two photodiodes. Further, the reset processes for the two photodiodes are performed at different timings. Then, when a predetermined exposure time has elapsed, the transfer transistors 42a and 42b are successively turned on, so that image pickup signals are output from the respective photodiodes. Further, in the image pickup device according to the fourth embodiment, when image pickup signals are output from different photodiodes, a reset process for the floating diffusion is performed after an output of an image pickup signal which is to be output at the previous timing is completed and before an output of an image pickup signal which is to be output at the present timing is started.

By using the circuit configuration in which one set of a reset transistor 43, an amplification transistor 44, and a selection transistor 45 is provided for two photodiodes as described above, the image pickup device according to the fourth embodiment can increase the ratio of the area for the photodiodes to the area for the pixel circuit. That is, the image pickup device according to the fourth embodiment can increase the number of photodiodes that can be formed in the same area compared to the number of photodiodes in the first embodiment.

### Fifth Embodiment

In a fifth embodiment, a modified example of the pixel circuit according to the first embodiment is explained. Note that in the explanation of the fifth embodiment, the same symbols as those in the first embodiment are assigned to the same components as those explained in the first embodiment and their explanations are omitted.

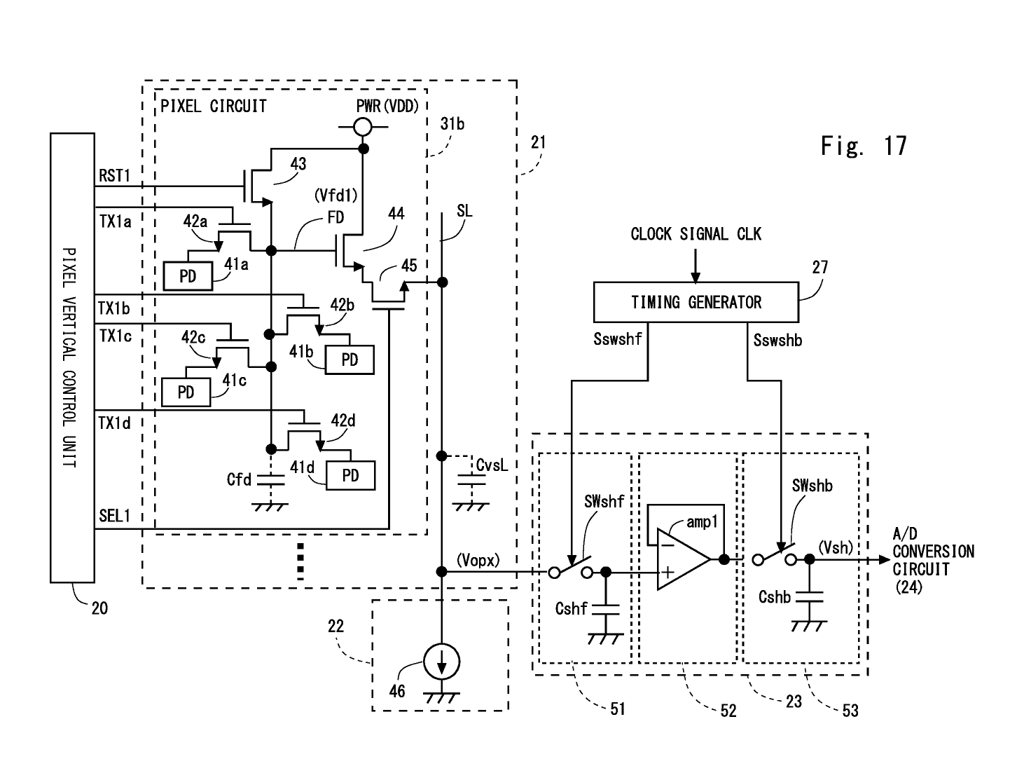

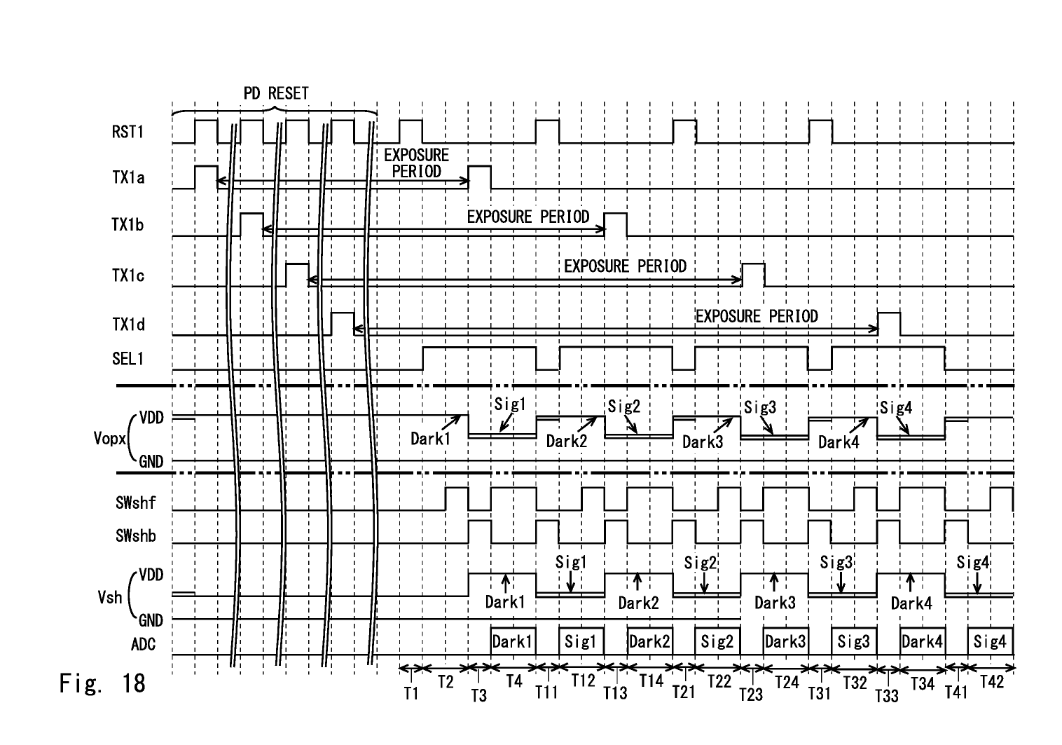

FIG. 17 shows a circuit diagram of a pixel circuit, a pixel current source, and an amplification circuit of an image pickup device according to the fifth embodiment. Note that a pixel array 21 according to the fifth embodiment includes pixel circuits 31b to 3nb. However, since the pixel circuits 31b 3nb are identical to each other, only the pixel circuit 31b is shown with its detailed circuit configuration.

As shown in FIG. 17, the pixel circuit 31b according to the fifth embodiment includes four pairs of photodiodes and transfer transistors for one set of a reset transistor 43, an amplification transistor 44, and a selection transistor 45. In the example shown in FIG. 17, the pixel circuit 31b incudes therein photodiodes 41a to 41d, and transfer transistors 42a to 42d.

An operation performed by the image pickup device according to the fifth embodiment is explained hereinafter. Therefore, FIG. 18 shows a timing chart for explaining details of the pixel reading operation performed by the image pickup device according to the fifth embodiment.

As shown in FIG. 18, in the image pickup device according to the fifth embodiment, the operations performed by the amplification circuit 23, the timing generator 27, and the analog/digital conversion circuit 24 are the same as those in the first embodiment. However, control for outputting a signal from a pixel circuit in the fifth embodiment differs from the control in the first embodiment. Therefore, the difference in the method for controlling the pixel circuit is explained.

As shown in FIG. 18, in the pixel circuit according to the fifth embodiment, reset processes for the four photodiodes are performed in a period that is before pixel signals are taken from the four photodiodes. Further, the reset processes for the four photodiodes are performed at different timings. Then, when a predetermined exposure time has elapsed, the transfer transistors 42a to 42d are successively turned on, so that image pickup signals are output from the respective photodiodes. Further, in the image pickup device according to the fifth embodiment, when image pickup signals are output from different photodiodes, a reset process for the floating diffusion is performed after an output of an image pickup signal which is to be output at the previous timing is completed and before an output of an image pickup signal which is to be output at the present timing is started.

By using the circuit configuration in which one set of a reset transistor 43, an amplification transistor 44, and a selection transistor 45 is provided for four photodiodes as described above, the image pickup device according to the fifth embodiment can increase the ratio of the area for the photodiodes to the area for the pixel circuit. That is, the image pickup device according to the fifth embodiment can increase the number of photodiodes that can be formed in the same area compared to the number of photodiodes in the first and fourth embodiments.

### Sixth Embodiment

In a sixth embodiment, a modified example of the pixel circuit according to the first embodiment is explained. Note that in the explanation of the sixth embodiment, the same symbols as those in the first embodiment are assigned to the same components as those explained in the first embodiment and their explanations are omitted.

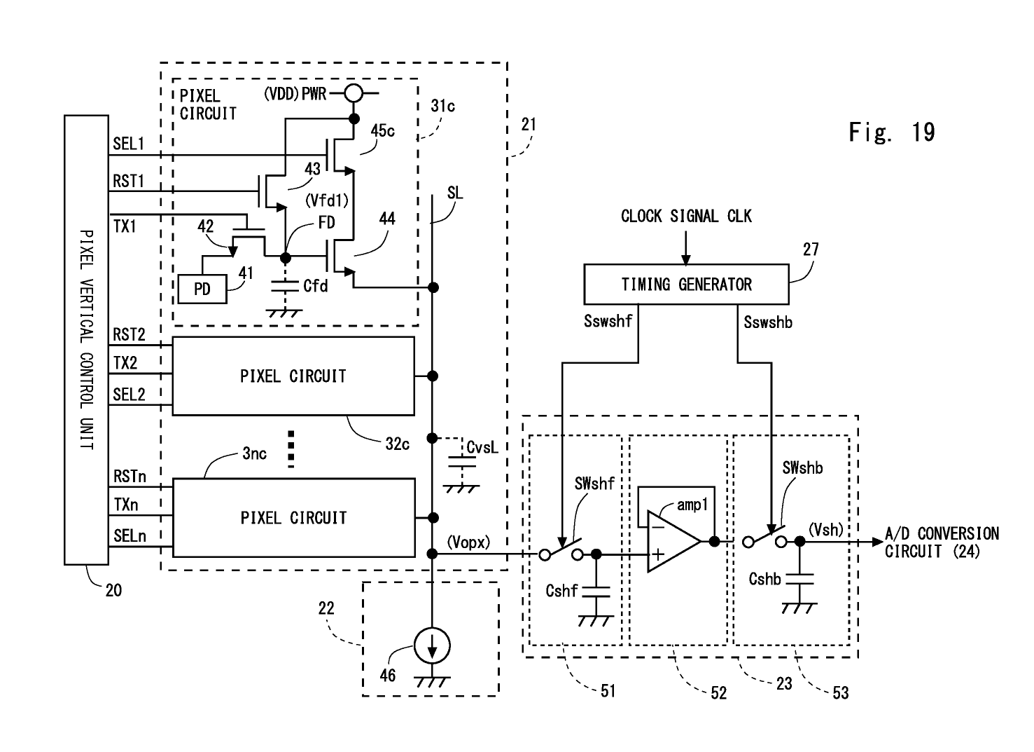

FIG. 19 shows a circuit diagram of a pixel circuit, a pixel current source, and an amplification circuit of an image pickup device according to the sixth embodiment. Note that a pixel array 21 according to the sixth embodiment includes pixel circuits 31c to 3nc. However, since the pixel circuits 31c to 3nc are identical to each other, only the pixel circuit 31c is shown with its detailed circuit configuration.

As shown in FIG. 19, the pixel circuit 31c according to the sixth embodiment includes a selection transistor 45c disposed between the drain of the amplification transistor 44 and the power supply line PWR. Meanwhile, the selection transistor 45 included in the pixel circuit 31 according to the first embodiment is removed and a source of the amplification transistor 44 is directly connected to the vertical signal line SL. That is, the pixel circuit 31c according to the sixth embodiment is obtained by changing the location of the selection transistor of the pixel circuit 31 according to the first embodiment. The operation of the image pickup device including this pixel circuit 31c according to the sixth embodiment is the same as the operation of the image pickup device 15 according to the first embodiment shown in FIG. 7 and therefore the explanation of the operation of the image pickup device according to the sixth embodiment is omitted.

As described above, the location of the selection transistor in the pixel circuit is not limited to the location of the pixel circuit 31 explained in the first embodiment. That is, various embodiments are conceivable.

### Seventh Embodiment

In a seventh embodiment, a modified example of the pixel according to the first embodiment is explained. Note that in the explanation of the seventh embodiment, the same symbols as those in the first embodiment are assigned to the same components as those explained in the first embodiment and their explanations are omitted.

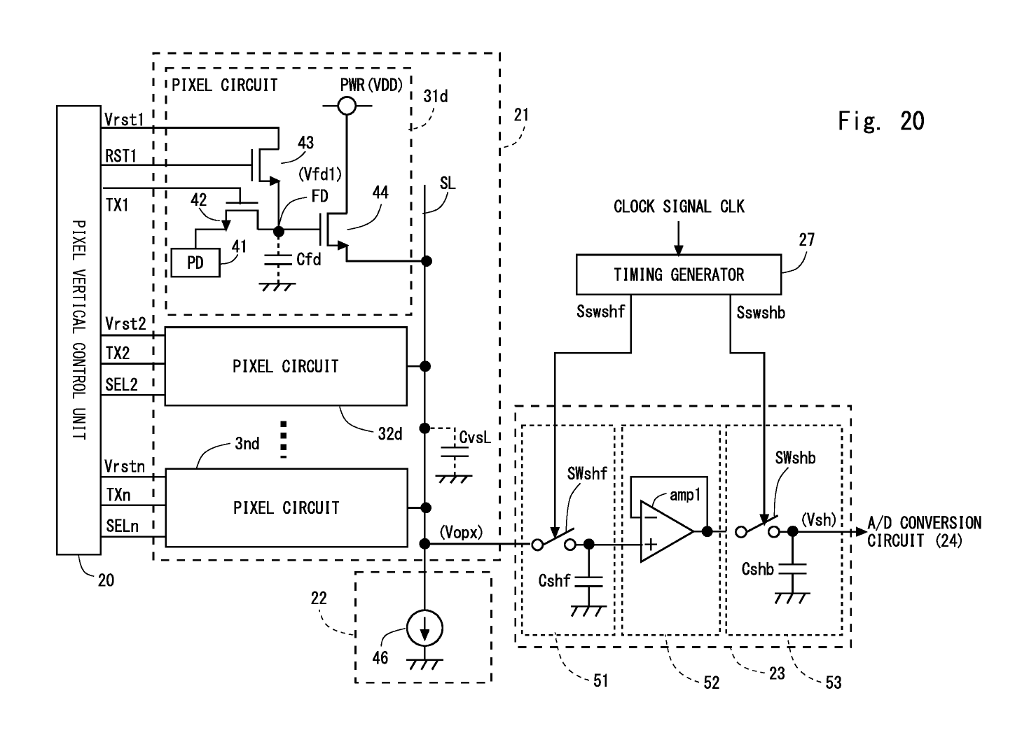

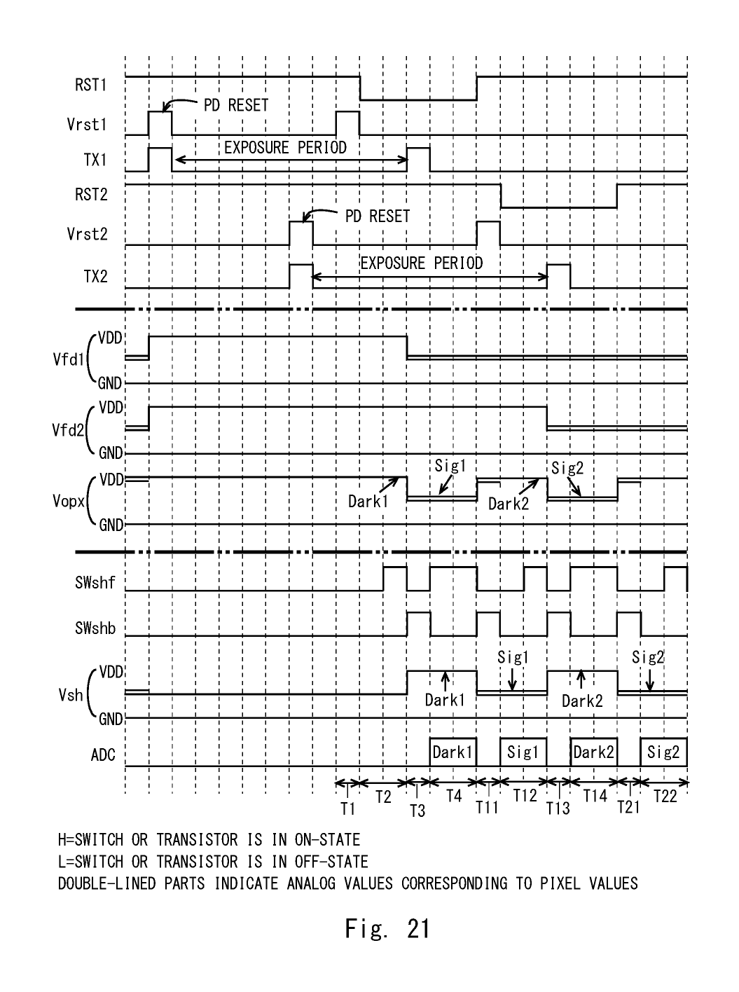

FIG. 20 shows a circuit diagram of a pixel circuit, a pixel current source, and an amplification circuit of an image pickup device according to the seventh embodiment. Note that a pixel array 21 according to the seventh embodiment includes pixel circuits 31d to 3nd. However, since the pixel circuits 31d to 3nd are identical to each other, only the pixel circuit 31d is shown with its detailed circuit configuration.

As shown in FIG. 20, in the pixel circuit 31d according to the seventh embodiment, the selection transistor 45 of the pixel circuit 31 is removed and a source of the amplification transistor 44 is directly connected to the vertical signal line SL. Further, in the pixel circuit 31d according to the seventh embodiment, a reset power supply line Vrst1 is connected to the drain of the transfer transistor 42. In the pixel circuit 31d according to the seventh embodiment, whether the amplification transistor 44 should be activated or not is controlled by controlling the voltage supplied to the drain of the transfer transistor 42 and the opened/closed state of the transfer transistor 42 through the reset power supply line Vrst1. By this activation control, the same operation is performed as the operation that is performed in the circuit including the selection transistor 45. Accordingly, the operation performed by the pixel circuit 31d is explained with reference to FIG. 21. FIG. 21 shows a timing chart for explaining details of a pixel reading operation performed by the image pickup device according to the seventh embodiment.

As shown n FIG. 21, even in the seventh embodiment, the operations performed by the amplification circuit 23, the timing generator 27, and the analog/digital conversion circuit 24 are the same as those in the first embodiment. However, control for outputting a signal from a pixel circuit in the seventh embodiment differs from the control in the first embodiment. Therefore, the difference in the method for controlling the pixel circuit is explained.

As shown in FIG. 21, in the pixel circuit 31d according to the seventh embodiment, the reset control signal is brought into a low level and the transfer transistor 42 is thereby turned off in a period from when a reset process for the floating diffusion is completed to when the output of the pixel circuit is completed, i.e., in a period in which the selection transistor 45 of the pixel circuit 31 is in an on-state. In this way, in a period in which a signal needs to be output from the pixel circuit to the vertical signal line SL, the amplification transistor 44 outputs a signal having a voltage level corresponding to the voltage of the floating diffusion to the vertical signal line SL. Meanwhile, in the pixel circuit 31d, when a reset process for the photodiode and the floating diffusion is performed, the voltage that is supplied to the drain of the transfer transistor 42 through the reset power supply line in a state where the transfer transistor 42 is in an on-state is set to the reset voltage. Further, in the pixel circuit 31d, in a period in which the reset process for the photodiode and the floating diffusion is not performed, the voltage that is supplied to the drain of the transfer transistor 42 through the reset power supply line in the state where the transfer transistor 42 is in an on-state is set to a low level (e.g., a ground voltage). In this way, since the voltage by which the amplification transistor 44 is brought into an off-state is supplied to the gate of the amplification transistor 44, no signal is output from the pixel circuit 31d to the vertical signal line SL.

As described above, since the operation similar to the operation for the opened/closed state of the selection transistor is performed by using the reset control signal and the reset power supply line Vrst in the pixel circuit, the selection transistor 45 can be removed from the pixel circuit. In this way, in the image pickup device according to the seventh embodiment, it is possible to reduce the circuit area of the pixel circuit and thereby to arrange a larger number of pixels in the chip.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first to seventh embodiments can be combined as desirable by one of ordinary skill in the art.

What is claimed is:

1. An image pickup device comprising:
a pixel circuit configured to output a dark level signal having a signal level corresponding to a predefined reset level and an image pickup signal having a signal level corresponding to an amount of received light at different timings;
a first sampling-and-holding circuit configured to sample a signal output from the pixel circuit;
a buffer circuit configured to amplify a signal held in the first sampling-and-holding circuit;
a second sampling-and-holding circuit configured to sample a signal output from the buffer circuit;
an analog/digital conversion circuit configured to generate a digital value corresponding to a signal held in the second sampling-and-holding circuit; and
a timing control circuit configured to control a sampling operation and a holding operation performed by the first and second sampling-and-holding circuits.

2. The image pickup device according to claim 1, wherein the timing control circuit controls the first and second sampling-and-holding circuits so that:
a sampling operation for the dark level signal performed by the first sampling-and-holding circuit and a sampling operation performed by the second sampling-and-holding circuit are performed successively at different timings;
a sampling operation for the image pickup signal by the first sampling-and-holding circuit is performed during a period in which the second sampling-and-holding circuit holds the dark level signal; and
a sampling operation for the image pickup signal by the second sampling-and-holding circuit is performed successively at a different timing later than the sampling operation performed by the first sampling-and-holding circuit.

3. The image pickup device according to claim 1, further comprising a pixel value generation circuit configured to output a difference between a dark level value corresponding to the dark level signal and a pixel value corresponding to a signal level of the image pickup signal as a picture-element value, the dark level value and the pixel value being output at different timings by the analog/digital conversion circuit.

4. The image pickup device according to claim 1, wherein each of the first and second sampling-and-holding circuits comprises:
a switch disposed between an input end for a signal and an output end therefore; and
a capacitor disposed between the output end and a ground line.

5. The image pickup device according to claim 1, further comprising a variable-gain amplifier disposed between a vertical signal line to which a signal output from the pixel circuit is transmitted and the first sampling-and-holding circuit.

6. The image pickup device according to claim 1, further comprising a succeeding buffer circuit disposed between the second sampling-and-holding circuit and the analog/digital conversion circuit.
